(19) United States
(12) Patent Application Publication
(10) Pub. No.: US 2009/0135733 A1
(43) Pub. Date: May 28, 2009

(54) COMMUNICATION DEVICE, COMMUNICATION SYSTEM, AND METHOD FOR MONITORING COMMUNICATION QUALITY BETWEEN COMMUNICATION DEVICES

(76) Inventor: KOHEI OKAZAKI, Tokyo (JP)

Correspondence Address: NEC CORPORATION OF AMERICA, 6535 N. STATE HWY 161, IRVING, TX, 75039, US

(21) Appl. No.: 12/277,505

(22) Filed: Nov. 25, 2008

(30) Foreign Application Priority Data
Nov. 27, 2007 (JP) 2007-305634

(51) Int. Cl. G06F 11/30

(52) U.S. Cl. 370/252

(57) ABSTRACT

The present invention provides a communication device, communication system, and a method for monitoring the communication quality between communication devices, in which it is ensured that the transmitting side and the receiving side can collect statistical information within the same time period. Its configuration is a method for measuring communication quality between communication devices which perform packet transmission, wherein the transmitting side communication device sends out a marker frame indicating a start and an end of a time period for measuring communication quality in which the time period is constant, and collects statistical information of transmission packets within said measurement time period, wherein the receiving side communication device recognizes the start and end of the measurement time period from the reception time of the marker frame, and collects statistical information of reception packets within the measurement time period, and wherein the communication quality is measured by statistical information of the transmission packets and the reception packets within the measurement time period.

This application is based upon and claims the benefit of priority from Japanese patent application No. 2007-305634, filed on Nov. 27, 2007, the disclosure of which is incorporated herein in its entirety by reference.

### BACKGROUND OF THE INVENTION

1. Field of the Invention

The present invention relates to a method for monitoring the quality of communication between communication devices.

2. Description of the Related Art

In order to provide higher quality services to users in digital communication, a monitor function called a “performance monitor (PM)” which monitors the state of communication lines is known. The PM function is used as a function for confirming the quality of signals inputted to a device which receives data frames transmitted from a communication device on the transmitting side.

In recent years, packet switched networks represented by IP (Internet Protocol) have been in widespread use. Moreover, technologies for communicating packets on a highly reliable SONET (Synchronous Optical Network)/SDH network have become widespread so that not only data communication but also audio communication may be performed by packet switching. Therefore, it is very important to take into consideration a high level of reliability in the packet switched networks.

Techniques to control the quality of communication are disclosed in Patent Document 1 (Japanese Patent Laid-Open No. 2003-348106), Patent Document 2 (Japanese Patent Laid-Open No. 2004-128631), and Patent Document 3 (Japanese Patent Laid-Open No. 09-172437).

Patent Document 1 discloses a system for measuring bandwidth to improve the usage efficiency of a network, by addressing the problem in which when the buffer read rate in a device is maintained regardless of the transmission line rate, a discrepancy may take place between the transmission line rate and the data delivery rate, thereby wasting the bandwidth.

Patent Document 1 discloses a configuration in which measurement packets are transmitted so that the band width is measured from the number of packets which are returned to the own device within a predetermined time period.

The invention disclosed in Patent Document 2 aims at realizing more reliable beam switching for mobile stations in a multi-beam satellite communication system while suppressing an increase in the hardware scale of the mobile station. In a multi-beam satellite communication system, a problem exists in which, when the quality of communication line is degraded due to a temporal degradation of the line, line switching may take place even if the beam area is not shifted.

In the invention disclosed in Patent Document 2, in order to solve the above described problem, packets received through both communication lines in the current area and a neighboring area are used to measure the quality of the communication line so that the area is switched according to the measurement result.

The configuration is such that a measurable packet is transmitted from a gateway station to a mobile station, and when the mobile station receives the measurable packet, the mobile station stops receiving data packets for measuring the quality of the current area and the neighboring areas, and is such that the receiver for receiving data packets and the receiver for the measurable packet are unified rather than being separated so as to reduce the size reduction of the mobile station. As a result, data reception and quality measurement need to be switched and the measurable packet is used for mode switching.

Patent Document 3 discloses that an error check symbol is generated by utilizing a transmitted frame to generate and transmit a monitoring packet including the generated error check symbol, and when the monitoring packet is received by a receiving side, the receiving side performs an error check calculation by using the monitoring packet to determine the error rate of the transmission line.

As so far described, there are various forms of techniques to control the quality of communication. Between communication devices which perform packet switching, it is possible to collect information on duplication, disposal, and to miss delivery of packets, and the number of data frames disposed in the originating device by counting the data frames subjected to transmission or reception processing in each communication device and by verifying them.

However, since statistical information is collected by counting data frames at a timing unique to each communication device, the transmitting side and receiving side cannot collect statistical information during the same time period, and therefore cannot compare them.

Among the above described Patent Documents, in the technique disclosed in Patent Document 1, the bandwidth is measured from the number of packets which are transmitted and returned to the originating device within a predetermined time. As a result, the technique can be applied only to networks in which paths are explicitly defined like a ring network as described in its exemplary embodiment, and therefore the transmitting side and the receiving side cannot obtain the same statistical information.

In the technique according to Patent Document 2, because of the configuration in which a measurable packet is transmitted from a gateway station to a mobile station, and in which the mobile station stops receiving the data packets upon receiving the measurable packet and measures the qualities of the current area and the neighboring areas, it is not possible to count the data frames which are actually processed.

In the technique according to Patent Document 3, although error check calculation is started as soon as a monitoring packet is received, since the check time period is not specified in this scheme, the technique cannot be applied to collecting statistical information during the same time period by the transmitting side and the receiving side.

### SUMMARY OF THE INVENTION

The present invention provides a technique which will ensure that the transmitting side and the receiving side can collect statistical information during the same time period.

The method for measuring the communication quality between communication devices of the present invention is a method for measuring the communication quality between communication devices which perform packet transmission, comprising:

at a transmitting side communication device, sending out a marker frame, which indicates a start and an end of a measurement time period for measuring communication quality, to collect statistical information of a transmission packet within the above described measurement time period,

at a receiving side communication device, recognizing the start and end of the measurement time period from the above described marker frame to collect statistical information of a reception packet within the above described measurement time period, and

measuring the communication quality from the statistical information of the transmission packet and the reception packet within the above described measurement time period.

The communication device of the present invention is a communication device for performing packet transmission, comprising:

a transmitter module for sending out a marker frame, which indicates a start and an end of a time period for measuring communication quality, to collect and retain statistical information of a transmission packet within the above described measurement time period, and

a receiver module for recognizing the start and the end of the measurement time period through reception of the above described marker frame for collecting and retaining statistical information of a reception packet within the above described measurement time period.

The communication system of the present invention uses the above described communication device.

### BRIEF DESCRIPTION OF THE DRAWINGS

FIG. 1 is a block diagram to show respective configurations of an exemplary embodiment of transmitter module 1 provided in the communication device according to the present invention;

FIG. 2 is a block diagram to show respective configurations of an exemplary embodiment of receiver module 11 provided in the communication device according to the present invention;

FIG. 3 shows a communication state between the communication devices according to the present invention;

FIG. 4 is a flowchart to show the operation of transmitter module 1 shown in FIG. 1, when the operation includes transmitting one marker frame;

FIG. 5 is a flowchart to show the operation of transmitter module 1 shown in FIG. 1, when the operation includes transmitting n marker frames;

FIG. 6 is a flowchart to show the operation of receiver module 11 shown in FIG. 2, when the operation includes receiving one marker frame; and

FIG. 7 is a flowchart to show the operation of receiver module 11 shown in FIG. 2, when the operation includes receiving n marker frames.

### EXEMPLARY EMBODIMENT

Next, exemplary embodiments will be described with reference to the drawings.

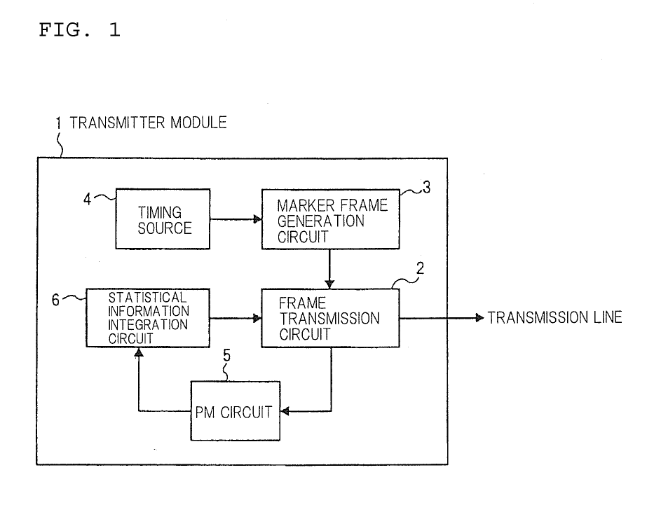

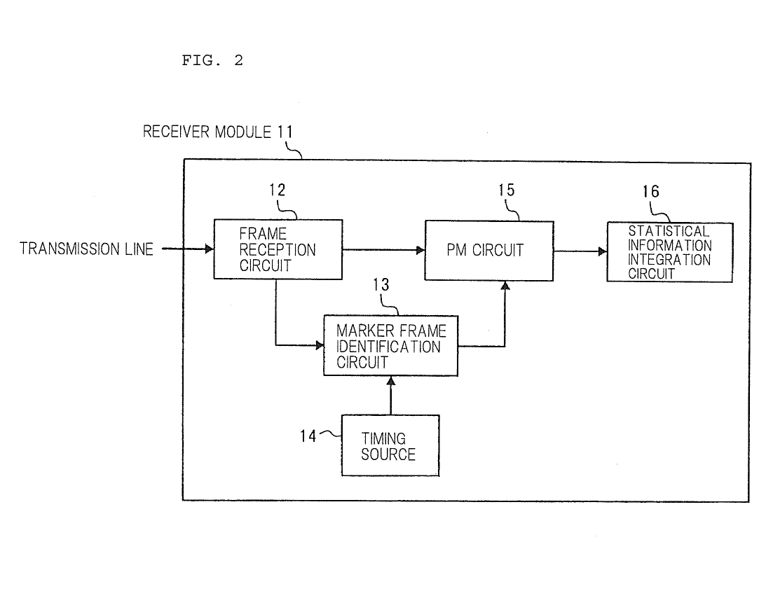

FIGS. 1 and 2 are block diagrams to respectively show the configurations of an exemplary embodiment of transmitter module 1 and receiver module 11 provided in the communication device according to the present invention. The communication device provided with transmitter module 1 and receiver module 11 is a device which performs packet switching and its function will not be particularly limited as long as it performs packet switching. Although the communication device, in which transmitter module 1 and receiver module 11 are provided, comprises various functional blocks, which perform processing through exchanged packets, in addition to the configurations shown in FIGS. 1 and 2, the configurations and operations of these functional blocks are commonly known and are not particularly related to the present invention, which are therefore omitted in FIGS. 1 and 2 as well as in the description.

Transmitter module 1 shown in FIG. 1 comprises frame transmission circuit 2, marker frame generation circuit 3, timing source 4, PM circuit 5, and statistical information integration circuit 6.

Timing source 4 supplies a clock which works as the basis of the operations of each functional block and the circuit in each functional block in a communication device in which transmitter module 1 is provided. Although it also supplies a clock for each part of transmitter module 1, the clock that is supplied to marker frame generation circuit 6 is shown in FIG. 1.

Marker frame generation circuit 3 generates a marker frame based on the clock supplied from timing source 4, and outputs it to frame transmission circuit 2.

Frame transmission circuit 2 performs processing to transmit the data frame generated at other functional blocks in the communication device, and marker frames, which have been sent from marker frame generation circuit 3, to the transmission line and PM circuit 5.

PM circuit 5 collects statistical information of the data frame transmitted from frame transmission circuit 2 and outputs it to statistical information integration circuit 6. Statistical information integration circuit 6 stores the statistical information collected at PM circuit 5 for a predetermined time period.

The marker frame generated by marker frame generation circuit 3 specifies the timing at which the integration of statistical information is started, and data which indicates that the frame is a marker frame is written in an unused area in the header part. One or n marker frames which are given sequence numbers are created for every statistical information integration period T based on the clock received from timing source 4, and are outputted to frame transmission circuit 2. When a plurality of marker frames are transmitted, n marker frames are supposed to be successively transmitted at a minute time interval “t”.

In this respect, statistical information integration period T represents the period at which statistical information is collected, and is determined by the communication device. Further, it is supposed that minute time interval t is sufficiently small compared to the period T at which statistical information is collected.

Since the marker frame is used so that the communication device on the receiving side can recognize the collection time period of statistical information, its frame size may be small in order to decrease the influence on other communication devices, but a high priority is given for transmission of the marker frame such that loss will not take place during transmission.

It is noted that PM circuit 5, statistical information integration circuit 6, and timing source 4 may be shared by other functional blocks in the communication device, and may also be installed outside transmitter module 1.

Receiver module 11 shown in FIG. 2 comprises frame reception circuit 12, marker frame identification circuit 13, timing source 14, PM circuit 15, and statistical information integration circuit 16.

Timing source 14 supplies a clock which works as the basis for the operations of each functional block and the circuit in each functional block in a communication device in which receiver module 11 is provided. Although it also supplies a clock signal for each part of receiver module 11, the clock that is supplied to marker frame identification circuit 13 is shown in FIG. 2.

Frame reception circuit 12 receives a data frame from the transmission line, and outputs it to marker frame identification circuit 13 and PM circuit 15. PM circuit 15 collects statistical information from the received data frame, and outputs it to statistical information integration circuit 16. Statistical information integration circuit 16 stores the statistical information collected at PM circuit 15 for a predetermined time period.

Marker frame identification circuit 13 identifies and detects if a received data frame is a marker frame by referencing the header part of the received data frame and when detecting a marker frame, it notifies PM circuit 15 that a marker frame has been detected, to indicate that it is statistical information integration period T.

PM circuit 15, which has received the detection notification of a marker frame from marker frame identification circuit 13, transmits the statistical information collected for statistical information integration period T to statistical information integration circuit 16, and resets its own counter. Then, it starts the collection of statistical information of the next period. Statistical information integration circuit 16 retains the statistical information transmitted from PM circuit 15.

It is noted that PM circuit 15, statistical information integration circuit 16, and timing source 14 may be shared by other functional blocks in the communication device, and may also be installed outside receiver module 11.

Each of marker frame generation circuits 3 and each of marker frame identification circuits 13 commonly recognizes the number of marker frames which indicate the start and end timings of statistical information integration period T, and also commonly recognizes statistical information integration period T and time interval t when the number of marker frames is “n”.

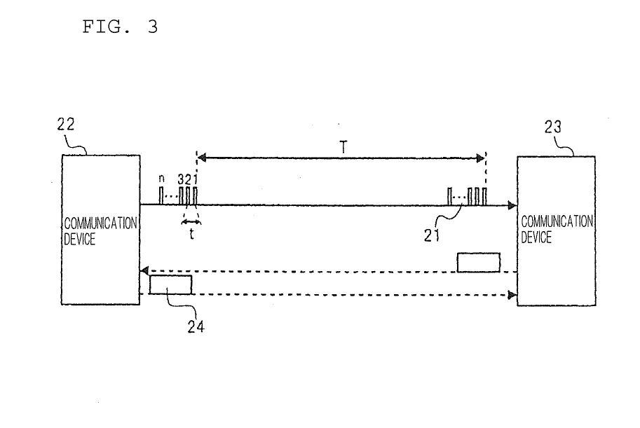

FIG. 3 shows a communication state between communication devices 22 and 23 according to the present invention, where the reception processing uses marker frames, and an example of the determined result is shown, where, it is supposed that n marker frames are transmitted. Each of communication devices 22 and 23 is provided with transmitter module 1 and receiver module 11 shown in FIGS. 1 and 2.

From communication device 22, n marker frames 21 which are given sequence numbers are transmitted at time interval t which is much smaller than statistical information integration period T. Frame transmission circuit 2 of communication device 22 transmits marker frames 21 every t time period, starting at (n-1)t time period before statistical information integration period T. Upon detecting the reception of a marker frame, marker frame identification circuit 13 of communication device 23 of the receiving side calculates a statistical information integration time, which is the time at which a collection time period ends, from the sequence number.

When receiving n-th marker frame 21, marker frame identification circuit 13 transmits a detection signal of marker frame 21 to PM circuit 15 in order to represent the end of the time period for collecting statistical information. While marker frame identification circuit 13 calculates the end time of the collection time period, which has been calculated beforehand, when n-th marker frame 21 is not received at the calculated time, it notifies PM circuit 15 of a marker frame loss notification. The statistical information integration time to be used for this judgment is given a time width taking into consideration delay fluctuation due to the transmission line.

Statistical information integration circuits 6,16 of communication devices 22 and 23, which retain the number of received signals and the number of transmitted signals corresponding to statistical information integration period T, transmit integrated collection result 24 to opposing communication devices, respectively. The communication device, which has received collection result 24, compares the number of transmissions (or the number of receptions), which is owned by itself, with the number of receptions (or the number of transmissions) of the received collection result. By comparing the statistical information which is collected during the same time period, it is confirmed whether is a loss of data frame in the transmission line has occurred.

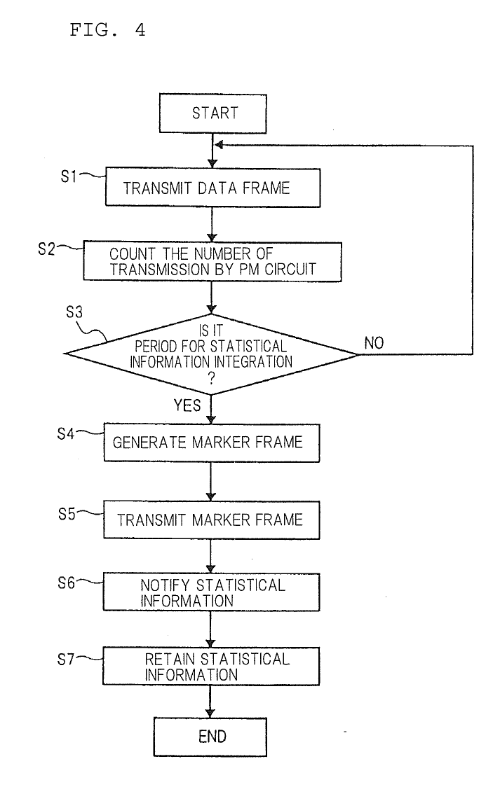

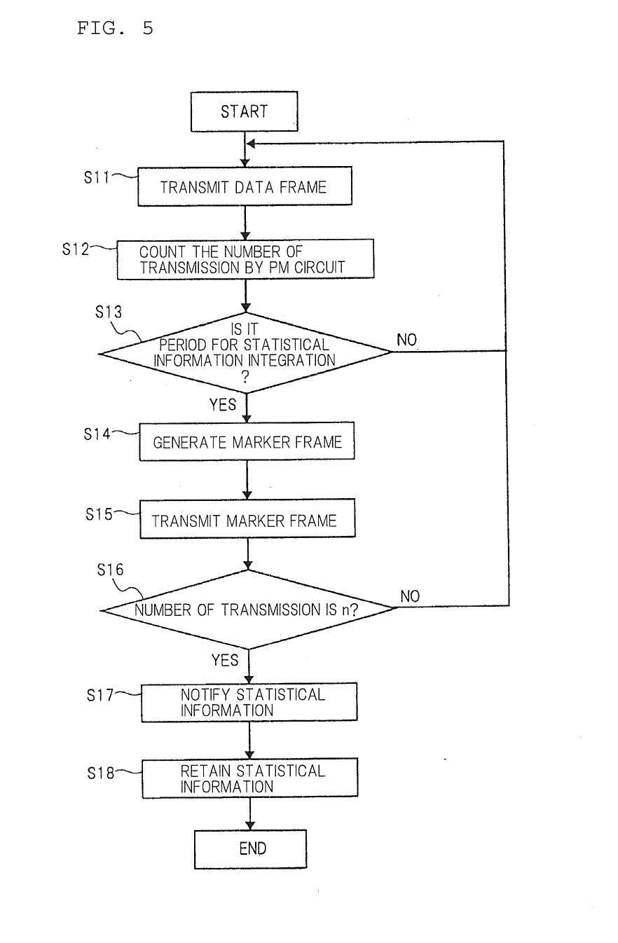

Next, the operation of transmitter module 1 shown in FIG. 1 will be described with reference to the flow charts shown in FIGS. 4 and 5. FIG. 4 is a flowchart to show the operation of transmitter module 1 when transmitting one marker frame, and FIG. 5 is a flowchart to show the operation of transmitter module 1 when transmitting n marker frames.

First, description will be made on the case in which one marker frame is transmitted with reference to FIG. 4.

In FIG. 4, when there is a data frame to be transmitted, data frame transmission circuit 2 of transmitter module 1 transmits the data frame to the transmission line and PM circuit 5 (step S1). Then, PM circuit 5 counts the number of data frames which has been sent (step S2).

Marker frame generation circuit 3 judges whether it is time to start Statistical information Integration Period T for integrating statistical information, by counting the clock signals supplied from timing source 4 (step S3). When marker frame generation circuit 3 judges that it is not time to start Statistical information Integration Period T for integrating statistical information, the process returns to step S1 and the above described operations are repeated.

When judging that it is the timing to start statistical information integration period T, marker frame generation circuit 3 creates a marker frame (step S4), and transmits the marker frame via data frame transmission circuit 2 to the transmission line and PM circuit 5 (step S5).

Upon receiving the marker frame, PM circuit 5 notifies statistical information, which includes information obtained by integrating the number of transmissions of data frames which have been collected so far, to statistical information integration circuit 6 (step S6), and starts the collection of statistical information thereafter. Statistical information integration circuit 6 retains statistical information which has been sent (step S7).

Statistical information accumulated in statistical information integration circuit 6 is transmitted through data frame transmission circuit 2 in order to perform the comparison with the statistical information of the communication device on the opposite side (step S8).

Next, referring to FIG. 5, description will be made of the case in which n marker frames are transmitted.

In FIG. 5, when there is a data frame to be transmitted, data frame transmission circuit 2 of transmitter module 1 transmits the data frame to the transmission line and PM circuit 5 (step S11). Then, PM circuit 5 counts the number of data frames which has been sent over (step S12).

Marker frame generation circuit 3 judges that it is time to start Statistical information Integration Period T for integrating statistical information, by counting the clock signals supplied from timing source 4 (step S13). When marker frame generation circuit 3 judges that it is not time to start Statistical information Integration Period T for integrating statistical information, the process returns to step S11 and the above described operations are repeated.

When judging that it is the timing to start statistical information integration period T, marker frame generation circuit 3 creates a marker frame (step S14), and transmits n marker frames at a minute interval t via data frame transmission circuit 2 to the transmission line and PM circuit 5 (step S15).

PM circuit 5 confirms if n marker frames have been transmitted (step S16). When the transmission of n marker frames are confirmed, PM circuit 5 notifies statistical information, which includes information obtained by integrating the number of transmissions of data frames which have been collected so far, to statistical information integration circuit 6 (step S17), and starts the collection of statistical information thereafter. Statistical information integration circuit 6 retains statistical information which has been sent over (step S18).

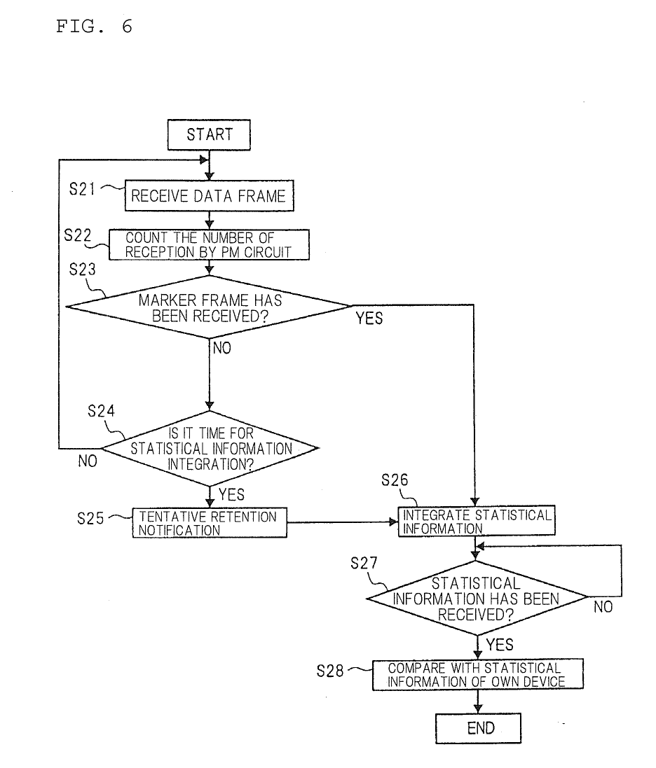

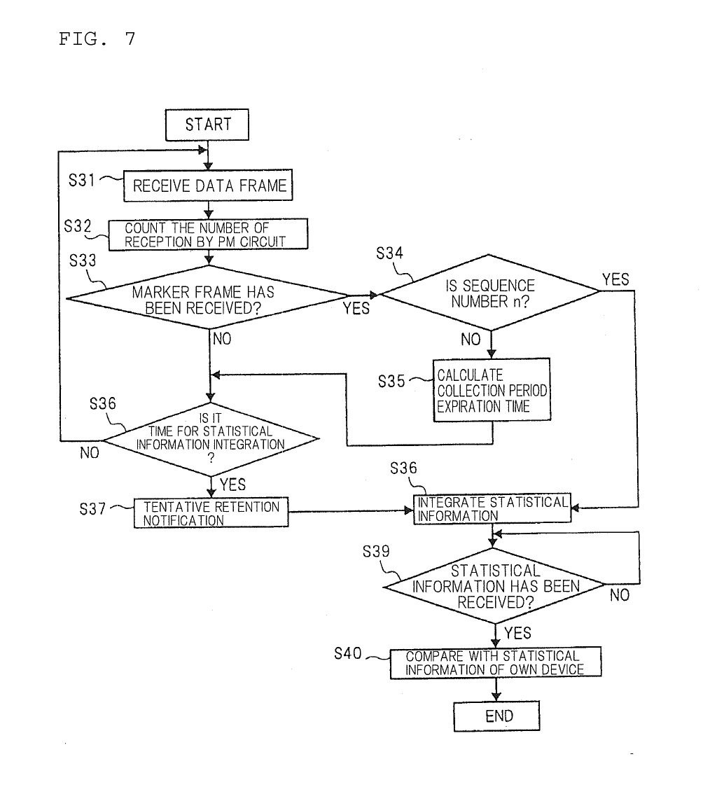

Next, the operation of receiver module 11 shown in FIG. 2 will be described using the flow charts shown in FIGS. 6 and 7. FIG. 6 is a flowchart to show the operation of receiver module 11 when receiving one frame marker, and FIG. 7 is a flowchart to show the operation of receiver module 11 when receiving n marker frames.

First, referring to FIG. 6, description will be made of the case in which one marker frame is received. When only one marker fame is transmitted as in the present exemplary embodiment, the time when statistical information integration period T has elapsed since the previous reception of marker frame is calculated as the statistical information integration time using timing source 14.

In FIG. 6, frame reception circuit 12 of receiver module 11 receives the data frame inputted from the transmission line (step S21), and outputs it to marker frame identification circuit 13 and PM circuit 15. PM circuit 15 counts the number of data frames which have been received (step S22).

In marker frame identification circuit 13, it is judged whether a marker frame is included in the received data frames (step S23). When a marker frame is not included in the received data frames in step S23, confirmation is made whether this is the time to integrate statistical information (step S24).

When it is confirmed that it is not a statistical information integration time in step S24, the process returns to step S21 and the above described operations are repeated, and when it is confirmed that it is a statistical information integration time, a tentative retention notification, which tentatively retains current statistical information, is notified to PM circuit 15 to indicate that a marker frame has not been received (step S25).

When it is confirmed that a marker frame has been received in step S23, or after step S25, PM circuit 15 notifies statistical information, which includes information obtained by integrating the number of transmissions of data frames which have been collected so far, to statistical information integration circuit 16, and starts the collection of statistical information thereafter. Statistical information integration circuit 16 retains statistical information which has been sent over (step S26).

Thereafter, in data frame reception circuit 12, when statistical information is received from the communication device on the opposite side (step S27), statistical information integration circuit 16 compares the statistical information of its own device with the statistical information of the communication device on the opposite side to judge if there has been loss of data frame in the transmission line (step S28).

Next, referring to FIG. 7, description will be made of the case in which n marker frames are received. When n marker frames are transmitted as in the present exemplary embodiment, the statistical information integration time is calculated from the sequence number and the minute interval t of the received marker frames using timing source 14.

In FIG. 7, frame reception circuit 12 of receiver module 11 receives a data frame inputted from the transmission line (step S31), and outputs it to marker frame identification circuit 13 and PM circuit 15. PM circuit 15 counts the number of data frames which have been received (step S32).

In marker frame identification circuit 13, it is judged whether a marker frame is included in received data frames (step S33).

When it is confirmed that a marker frame has been received in step S33, it is confirmed whether the sequence number of the received marker frame is n (step S34). When the sequence number is not n, the time for ending collection of statistical information is calculated from the sequence number of the received marker frame (step S35).

When it is confirmed that a marker frame has not been received in step S33, or when it is confirmed that the sequence number of the received marker frame is not n in step S34, confirmation is made whether this is the time to integrate statistical information (step S36).

When it is confirmed that it is not statistical information integration time in step S36, the process returns to step S31 and the above described operations are repeated, and when it is confirmed that it is statistical information integration time, a tentative notification to tentatively retain current statistical information is notified to PM circuit 15 to indicate that a marker frame has not been received (step S37).

When it is confirmed that the sequence number of a received marker frame is n in step S34, or after step S37, PM circuit 15 notifies statistical information, which includes information obtained by integrating the number of transmissions of data frames which have been so far collected, to statistical information integration circuit 16, and starts the collection of statistical information thereafter. Statistical information integration circuit 16 retains statistical information which has been sent (step S38).

Thereafter, when statistical information is received from the communication device on the opposite side at frame reception circuit 12 (step S39), statistical information integration circuit 16 compares the statistical information of its own device with the statistical information of the communication device on the opposite side to judge if there is loss of data frame in the transmission line (step S40).

In the present exemplary embodiment configured as described above, a marker frame is used to confirm whether this is statistical information integration period,. The exemplary embodiment is characterized in that it is made possible to accurately collect information on communication devices that perform transmission/reception, the number of transmissions of data frame between the communication devices, and number of losses in the transmission line by collecting statistical information according to a marker frame.

It is noted that the marker frame may be sent out at a predetermined time interval, or at irregular intervals at the time of measuring of communication quality.

Even when a marker frame is lost, since statistical information is sent out to the statistical information integration circuit when it becomes time to start a statistical information integration period, it is possible to accurately collect the number of transmissions/receptions of data frames between communication devices and the number of signal losses in the transmission line.

This will make it possible to realize highly reliable communication by using a simple algorithm without significantly increasing the circuits.

It is noted that when a marker frame is lost, there is possibility that collection will be performed for a longer time period than the actual collection time period because there will be period of waiting for a marker frame which has not yet been received. For that reason, either when a plurality of marker frames are used, or when one frame marker is used, the embodiment may be configured such that PM circuit 15 is supplied with statistical information which tentatively retains statistical information which has been collected until the end time determined by calculation.

Further, although it is described that statistical information integration circuits 6, 16 that retain the number of received signals and the number of transmitted signals for statistical information integration period T, respectively transmit integrated collection results to opposing communication devices, and compare the number of transmissions (or the number of receptions) which are retained by itself with the number of receptions (or the number of transmission) that comprise the collection result, this configuration is not so limited. For example, configuration may be such that a management center for managing the quality of communication between each communication device is provided, and each communication device sends the number of received signals and the number of transmitted signals corresponding to statistical information integration period T to the management center; and that the management center compares the statistical information collected in the same time period, thereby confirming whether there has been any loss of the data frames in communication and determining the communication quality, and switches the transmission line that connects each communication device depending on the result.

In the present exemplary embodiment, between communication devices performing communication, the communication device on the transmitting side sends out a marker frame indicating the start and end of measurement time period for measuring communication quality, and on the receiving side, collection of statistical information is performed according to the reception interval of the marker frame. Collecting statistical information according to the reception interval of the marker frame enables more accurate collection of information on the communication devices which perform transmission/reception, the numbers of transmissions/receptions of data frames between communication devices, and the number of losses in communication.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed:

1. A method for measuring a communication quality between communication devices which perform packet transmission, comprising:
at a transmitting side communication device, sending out a marker frame, which indicates a start and an end of a time period for measuring communication quality, to collect statistical information of a transmission packet within said measurement time period,
at a receiving side communication device, recognizing the start and the end of the measurement time period from said marker frame to collect statistical information of a reception packet within said measurement time period, and
measuring communication quality from the statistical information of the transmission packet and the reception packet within said measurement time period.

2. The method for measuring communication quality between communication devices according to claim 1, wherein
each of said transmitting side communication devices and each of said receiving side communication devices transmit collected statistical information of the transmission packet or the statistical information of the reception packet to an opposite communication device, and compare the statistical information retained by itself with the received statistical information to measure communication quality.

3. The method for measuring communication quality between communication devices according to claim 1, wherein
a marker frame comprises one packet, and
said receiving side communication device recognizes said measurement time period and, when a next marker frame is not received even when said measurement time period has ended after the reception of said marker frame, said receiving side communication device collects statistical information of said reception packet.

4. The method for measuring communication quality between communication devices according to claim 2, wherein
a marker frame comprises one packet, and
said receiving side communication device recognizes said measurement time period and, when a next marker frame is not received even when said measurement time period has ended after the reception of said marker frame, said receiving side communication device collects statistical information of said reception packet.

5. The method for measuring communication quality between communication devices according to claim 1, wherein
a marker frame comprises n packets which are given sequence numbers transmitted at a constant interval, and
said receiving side communication device recognizes said measurement time period and a marker frame transmission interval, and said receiving side communication device recognizes the end time of said measurement time period from the sequence number when said marker frame is received, and collects the statistical information of said reception packet when the marker frame indicating the end of said measurement time period is not received even if said end time has ended.

6. The method for measuring communication quality between communication devices according to claim 2, wherein
a marker frame comprises n packets which are given sequence numbers transmitted at a constant interval, and
said receiving side communication device recognizes said measurement time period and a marker frame transmission interval, and said receiving side communication device recognizes the end time of said measurement time period from the sequence number when said marker frame is received, and collects the statistical information of said reception packet when the marker frame indicating the end of said measurement time period is not received even if said end time has ended.

7. The method for measuring communication quality between communication devices according to claim 1, wherein
the communication quality is measured by comparing the number of transmission packets with the number of reception packets indicated on the statistical information of the transmission packet and the reception packet.

8. A communication device for performing packet transmission, comprising:
a transmitter module for sending out a marker frame, which indicates a start and an end of a measurement time period for measuring communication quality, and for collecting and retaining statistical information of a transmission packet within said measurement time period; and
a receiver module for recognizing the start and the end of the measurement time period through the reception of said marker frame, and for collecting and retaining statistical information of a reception packet within said measurement time period.

9. The communication device according to claim 8, wherein
said communication device transmits collected statistical information of a transmission packet or collected statistical information of a reception packet to an opposing communication device, and compares the collected statistical information that said communication device possesses owns, with the received statistical information to measure communication quality.

10. The communication device according to claim 8, wherein
said transmitter module transmits a marker frame comprising one packet,
said receiver module recognizes said measurement time period and when a next marker frame is not received even if said measurement time period has passed after the reception of said marker frame, collects statistical information of said reception packet.

11. The communication device according to claim 9, wherein
said transmitter module transmits a marker frame comprising one packet,
said receiver module recognizes said measurement time period and when a next marker frame is not received even if said measurement time period has passed after the reception of said marker frame, collects statistical information of said reception packet.

12. The communication device according to claim 8, wherein
said transmitter module transmits a marker frame comprising n packets which are given sequence numbers to be transmitted at a constant interval, and
said receiver module recognizes said measurement time period and the transmission interval of the marker frame, and when receiving said marker frame, recognizes the end time of said measurement time period from the sequence number thereof, and when the marker frame indicating the end of said measurement time period is not received even when said end time has passed, collects the statistical information of said reception packet.

13. The communication device according to claim 9, wherein
said transmitter module transmits a marker frame comprising n packets which are given sequence numbers to be transmitted at a constant interval, and
said receiver module recognizes said measurement time period and the transmission interval of the marker frame, and when receiving said marker frame, recognizes the end time of said measurement time period from the sequence number thereof, and when the marker frame indicating the end of said measurement time period is not received even when said end time has passed, collects the statistical information of said reception packet.

14. The communication device according claim 8, wherein
each of said transmitter modules and said receiver modules is adapted to measure communication quality by comparing the number of transmission packets with the number of reception packets which are indicated in the statistical information of the transmission packet and the reception packet.

15. A communication system, which utilizes the communication device according to claim 8.
